(19) United States
(12) Patent Application Publication
(10) Pub. No.: US 2002/0073310 A1
(43) Pub. Date: Jun. 13, 2002

(54) Method and system for a secure binding of a revoked X.509 certificate to its corresponding certificate revocation list

(75) Inventor: Messaoud Benantar, Austin, TX (US)

Correspondence Address: Joseph R. Burwell, Law Office of Joseph R. Burwell, P.O. Box 28022, Austin, TX, 78755-8022, US

(73) Assignee: IBM Corporation

(21) Appl. No.: 09/734,809

(22) Filed: Dec. 11, 2000

(51) Int. Cl. H04L 9/00

(52) U.S. Cl. 713/156

(57) ABSTRACT

A method, system, apparatus, and computer program product are presented for enabling an application that is validating a certificate to have a high level of assurance when checking the membership of a certificate within a particular certificate revocation list. First, the application checks whether a certificate's serial number is found within a certificate revocation list, and if there is a successful comparison within the serial numbers, then the fingerprint of the certificate is computed, preferably based on the digest algorithm specified by the certificate revocation list. The computed fingerprint is then compared to the certificate's fingerprint as previously stored within the certificate revocation list. If there is a successful comparison between the fingerprints, then the certificate can be properly invalidate or rejected, thereby lessening the chances that a valid certificate would be improperly rejected or invalidated.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer authentication.

2. Description of Related Art

The commercial use of the Internet has dramatically increased the use of technology. Web-based and Internet-based applications have now become so commonplace that when one learns of a new product or service, one assumes that the product or service will incorporate Internet functionality into the product or service. New applications that incorporate significant proprietary technology are only developed when an enterprise has a significantly compelling reason for doing so. Many corporations have employed proprietary data services for many years, but it is now commonplace to assume that individuals and small enterprises also have access to digital communication services. Many of these services are or will be Internet-based, and the amount of electronic communication on the Internet is growing exponentially.

One of the factors influencing the growth of the Internet is the adherence to open standards for much of the Internet infrastructure. Individuals, public institutions, and commercial enterprises alike are able to introduce new content, products, and services that are quickly integrated into the digital infrastructure because of their ability to exploit common knowledge of open standards.

Concerns about the integrity and privacy of electronic communication have also grown with adoption of Internet-based services. Various encryption and authentication technologies have been developed to protect electronic communication. For example, an open standard promulgated for protecting electronic communication is the X.509 standard for digital certificates.

An X.509 digital certificate is an International Telecommunications Union (ITU) standard that has been adopted by the Internet Engineering Task Force (IETF) body. It cryptographically binds the certificate holder, presumably the subject name within the certificate, with its public cryptographic key. This cryptographic binding is based on the involvement of a trusted entity within the Internet Public Key Infrastructure for X.509 certificates (PKIX) called the certifying authority (CA). As a result, a strong and trusted association between the certificate holder and its public key can become public information yet remain tamper-proof and reliable. An important aspect of this reliability is a digital signature that the certifying authority stamps on a certificate before it is released for use. Subsequently, whenever the certificate is presented to a system for use of a service, its signature is verified before the subject holder is authenticated. After the authentication process is successfully completed, the certificate holder may be provided access to certain information, services, or other controlled resources, i.e. the certificate holder may be authorized to access certain systems.

PKIX essentially manufactures and manages two different but closely related constructs: an X.509 certificate and an X.509 Certificate Revocation List (CRL). As noted above, a digital certificate provides an assurance, i.e. a certification, for a public key of the subject holding the certificate, whereas a CRL is the means by which a certifying authority announces the dissolution of the binding represented in a certificate. In other words, a CRL is the means by which the certifying authority declares that the previously issued certificate is no longer valid for use by applications.

Certificates are revoked when the security of the certificate or associated keys have been compromised in some manner, such as loss, theft, modification, or unauthorized disclosure of the private key. Certificates are permanently invalidated and cannot be unrevoked, resumed, reinstated, or otherwise reactivated, and a user whose certificate has been revoked must request that a new certificate be issued.

An issuing authority certifies a holder's public key by cryptographically signing the certificate data structure. Similarly, the revocation process is also certified by stamping the certifying authority's signature in the CRL data structure.

When the certifying authority issues the certificate, the certifying authority generates a unique serial number by which the certificate is to be identified, and this serial number is stored within the “Serial Number” field within the X.509 certificate. Currently, the only means by which a revoked X.509 certificate is identified within a CRL is through the certificate's serial number; a revoked certificate's serial number appears within a list of serial numbers within the CRL. This scheme has at least one potential weakness if the methodology is not followed exactly.

For example, if a first holder and a second holder were issued certificates with the same serial number by the same issuing authority, and the first holder's certificate were revoked such that the serial number was placed within a CRL, the second holder would be greatly inconvenienced. After the first holder's certificate has been revoked, the second holder's certificate would also be invalid because a verifying entity would find the serial number, ostensibly a unique number obtained from the second holder's certificate, within the CRL during a verification process and then deny privileges to the second holder.

This scheme puts a severe burden on a certifying authority to maintain the uniqueness of the serial numbers used by the certifying authority throughout the entire operating lifetime of the certifying authority. The certifying authority's source for generating those serial numbers must be proven correct and bug-free so that a serial number collision is avoided.

Hence, a potential problem arises because of the fact that a certificate's membership in a CRL is mostly decided based upon the certificate's serial number. If two certificates happen to correspond to the same serial number for any reason, the serial number's membership within a CRL will lead to erroneous but possibly unwarranted decisions. From a perspective of ensuring security, the determination that a certificate is valid or invalid is certainly of the same importance as the assurance that an X.509 certificate provides to its associated public key.

Therefore, it would be advantageous to have a method and system in which a level of assurance in deciding certificate membership within a CRL is equal to the level of assurance provided by PKIX in certification of public keys.

### SUMMARY OF THE INVENTION

A method, system, apparatus, and computer program product are presented for enabling an application that is validating a certificate to have a high level of assurance when checking the membership of a certificate within a particular certificate revocation list. First, the application checks whether a certificate's serial number is found within a certificate revocation list, and if there is a successful comparison within the serial numbers, then the fingerprint of the certificate is computed, preferably based on the digest algorithm specified by the certificate revocation list. The computed fingerprint is then compared to the certificate's fingerprint as previously stored within the certificate revocation list. If there is a successful comparison between the fingerprints, then the certificate can be properly invalidated or rejected, thereby lessening the chances that a valid certificate would be improperly rejected or invalidated.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a typical manner in which an entity obtains a digital certificate;

FIG. 3 is a block diagram depicting a typical manner in which an entity may use a digital certificate to be authenticated to an Internet system or application;

FIG. 4 depicts a block diagram showing a method of using a certificate revocation list in conjunction with a certificate fingerprint in accordance with a preferred embodiment of the present invention;

FIG. 5A shows some of the fields of a standard X.509 digital certificate;

FIG. 5B show some of the fields of an X.509 certificate revocation list;

FIG. 6 shows the structure of a certificate fingerprint for use within an X.509 certificate revocation list in accordance with a preferred embodiment of the present invention; and

FIG. 7 shows a flowchart depicting the processing of a certificate revocation list for authenticating a certificate holder on a system using the certificate fingerprint methodology of the present invention.

### DETAILED DESCRIPTION OF THE INVENTION

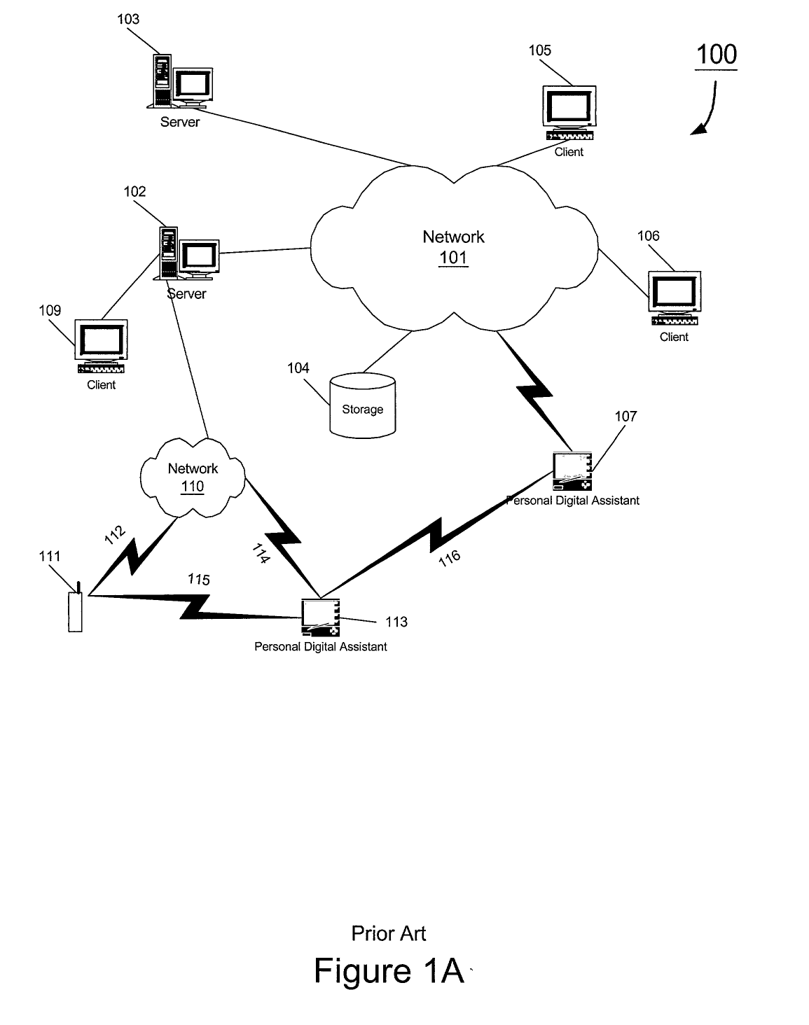

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing an authentication methodology that secures user access to applications or systems within a distributed data processing environment. To accomplish this goal, the present invention uses the trusted relationships associated with digital certificates in a novel manner to authenticate a user. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature. The present invention is directed to a form of authentication using digital certificates; some encryption is also performed during the processing within the present invention.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

The X.509 standard is one of many standards that defines the information within a certificate and describes the data format of that information. The “version” field indicates the X.509 version of the certificate format with provision for future versions of the standard. This identifies which version of the X.509 standard applies to this certificate, which affects what information can be specified in it. Thus far, three versions are defined. Version 1 of the X.509 standard for public key certificates was ratified in 1988. The version 2 standard, ratified in 1993, contained only minor enhancements to the version 1 standard. Version 3, defined in 1996, allows for flexible extensions to certificates in which certificates can be extended in a standardized and generic fashion to include additional information.

In addition to the traditional fields in public key certificates, i.e. those defined in versions 1 and 2 of X.509, version 3 comprises extensions referred to as “standard extensions”. The term “standard extensions” refers to the fact that the version 3 of the X.509 standard defines some broadly applicable extensions to the version 2 certificate. However, certificates are not constrained to only the standard extensions, and anyone can register an extension with the appropriate authorities. The extension mechanism itself is completely generic.

Other aspects of certificate processing are also standardized. The Certificate Request Message Format (RFC 2511) specifies a format recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org.

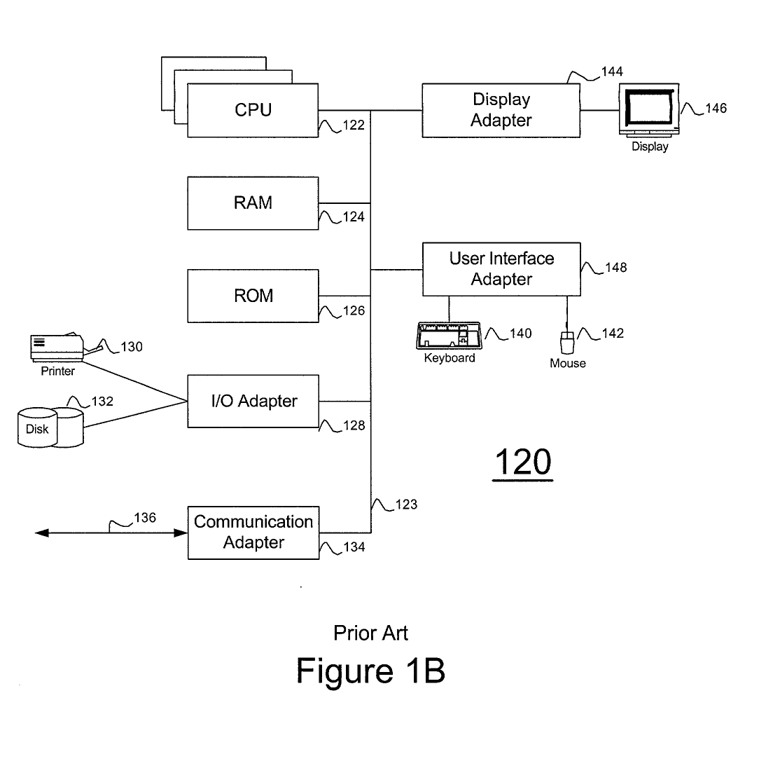

With reference now to FIG. 2, a block diagram depicts a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 218 that was signed with CA private key 214. User 202 receives newly generated digital certificate 216, and user 202 may then publish digital certificate 216 as necessary to engage in trusted transactions or trusted communications. An entity that receives digital certificate 216 may verify the signature of the CA by using CA public key 212, which is published and available to the verifying entity.

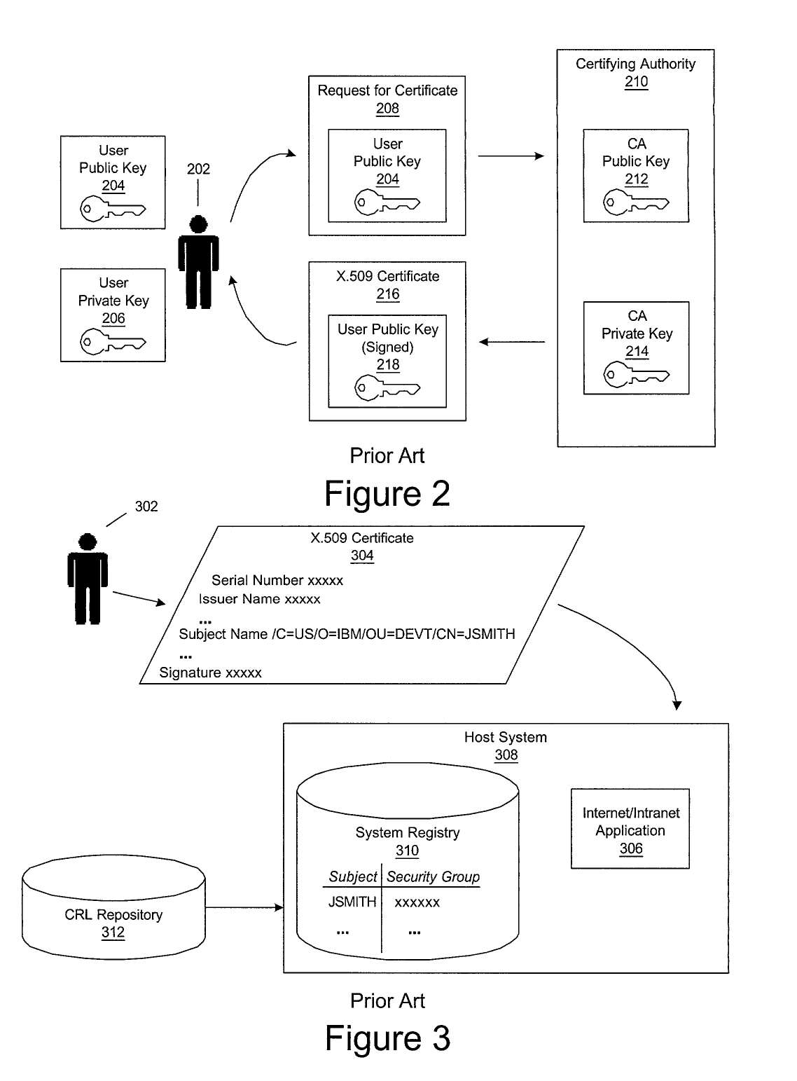

With reference now to FIG. 3, a block diagram depicts a typical manner in which an entity may use a digital certificate to be authenticated to an Internet system or application. User 302 possesses X.509 digital certificate 304, which is transmitted to an Internet or intranet application 306 that comprises X.509 functionality for processing and using digital certificates and that operates on host system 308. The entity that receives certificate 304 may be an application, a system, a subsystem, etc. Certificate 304 contains a subject name or subject identifier that identifies user 302 to application 306, which may perform some type of service for user 302.

Host system 308 may also contain system registry 310 which is used to authorize user 302 for accessing services and resources within system 308, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

In order to determine whether certificate 304 is still valid, host system 308 obtains a certificate revocation list (CRL) from CRL repository 312. Host system 308 compares the serial number within certificate 304 with the list of serial numbers within the retrieved CRL, and if there are no matching serial numbers, then host system 308 authenticates user 302. If the CRL has a matching serial number, then certificate 304 should be rejected, and host system 308 can take appropriate measures to reject the user's request for access to any controller resources.

As noted previously with respect to the prior art, when a certifying authority issues a certificate, the certifying authority generates a unique serial number by which the certificate is to be identified, and this serial number is stored within the “Serial Number” field within the X.509 certificate. Currently, the only means by which a revoked X.509 certificate is identified within a CRL is through the certificate's serial number; a revoked certificate's serial number appears within a list of serial numbers within the CRL. This scheme puts a severe burden on a certifying authority to maintain the uniqueness of the serial numbers used by the certifying authority throughout the entire operating lifetime of the certifying authority.

In contrast with the prior art methods of using a digital certificate, such as that shown in FIG. 3, the present invention provides a novel method by which to verify a certificate's inclusion within a certificate revocation list.

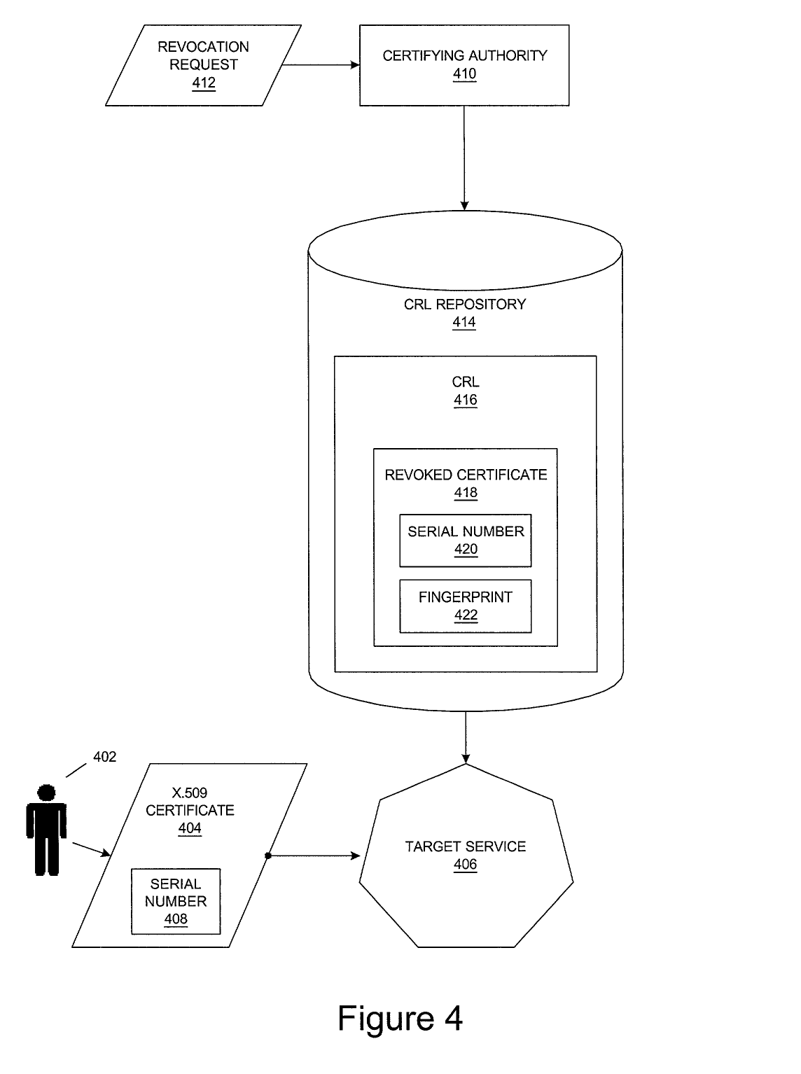

With reference now to FIG. 4, a block diagram shows a method of using a certificate revocation list in conjunction with a certificate fingerprint in accordance with a preferred embodiment of the present invention. User 402, a holder of digital certificate 404, presents certificate 404 to target service 406 to obtain access to a controller resource. Independently, certifying authority 410 receives revocation request 412, which requests that a particular certificate should be revoked, presumably by specifying a serial number. A certifying authority might revoke a certificate upon a verified request from a variety of entities, such as a financial institution, and then publish new or modified CRLs within a CRL repository. Certifying authority 410 manages CRL repository 414 that contains one or more CRLs, such as CRL 416.

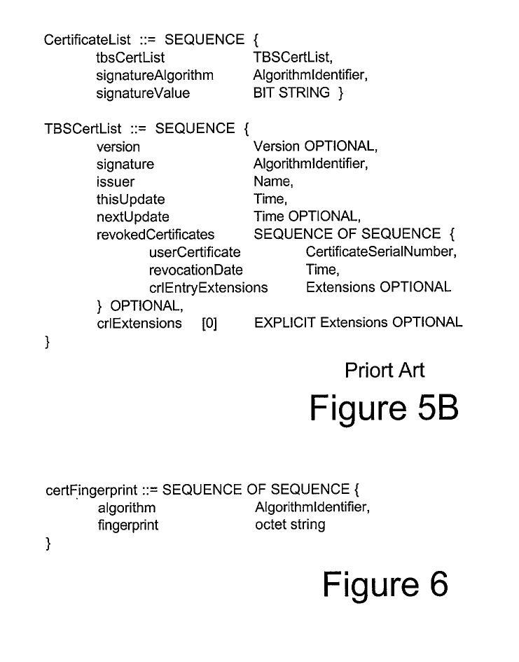

In the prior art, a CRL would simply contain one or more entries with serial numbers that identify the revoked certificates. In the present invention, an entry in a CRL corresponding to a revoked certificate contains both a serial number and an associated certificate fingerprint, which is explained in more detail further below with respect to FIG. 6. In response to the request for revocation of a certificate, certifying authority 410 generates an entry into a CRL, such as entry 418, representing the certificate that is being revoked. CRL entry 418 contains certificate serial number 420 and certificate fingerprint 422. Certificate fingerprint 422 is computed using a particular digest algorithm over the revoked certificate. Optionally, a digest algorithm identifier that identifies the digest algorithm that has been used to compute the certificate fingerprint is stored in association with the certificate fingerprint within the CRL. The certifying authority is able to compute the certificate fingerprint either from a stored or archived copy of the digital certificate or from the information that was originally used to generate the digital certificate.

After user 402 has presented certificate 404 to target service 406, target service 406 extracts serial number 408 from certificate 404 and retrieves CRL 416, either directly from CRL repository 414 or indirectly from certifying authority 410. Target service 406 searches CRL 416 for a serial number that matches serial number 408, and if a match is found, then target service 406 computes a certificate fingerprint for certificate 404 and compares the computed certificate fingerprint with certificate fingerprint 422. If the fingerprints match, then target service 406 presumably would reject the request by user 402 to access the controlled resource. If the fingerprints do not match, then target service 406 might perform some other processes with respect to user 402, such as authorization processes.

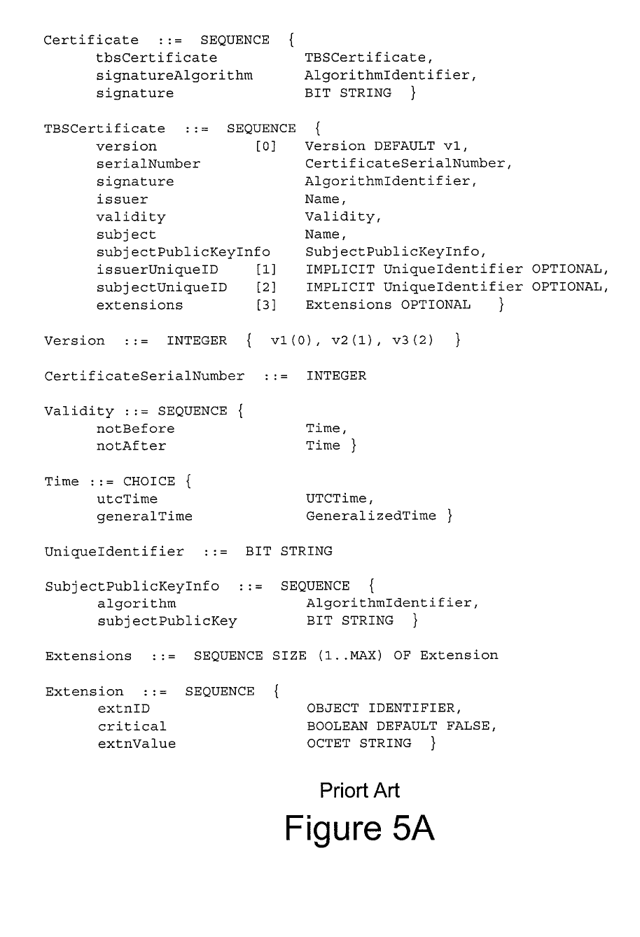

With reference now to FIG. 5A, some of the fields of a standard X.509 digital certificate are shown. The constructs shown in FIG. 5A are in Abstract Syntax Notation 1 (ASN.1) and are defined within the X.509 standard.

With reference now to FIG. 5B, some of the fields of an X.509 certificate revocation list are shown. Each revoked certificate is identified in a CRL using the construct shown in FIG. 5B, which is also in ASN.1 notation. Definitions for digital certificates and certificate revocation lists are specifically recited within “Internet X.509 Public Key Infrastructure Certificate and CRL Profile”, IETF RFC 2459, January 1999.

With reference now to FIG. 6, a diagram shows the structure of a certificate fingerprint for use within an X.509 certificate revocation list in accordance with a preferred embodiment of the present invention. The present invention takes advantage of the standard ASN.1 format of a CRL structure to include a cryptographic fingerprint, i.e. digest or hash, of the certificate being revoked.

A standard CRL contains one or more entries for revoked certificates with one revoked certificate specified per entry. A standard CRL may contain one or more extensions for the CRL as a whole, and each entry within the CRL may also contain one or more extensions.

In the present invention, a certificate fingerprint of a revoked certificate is computed and stored as a CRL entry extension within the CRL entry for the revoked certificate. As explained in RFC 2459, the CRL entry extensions already defined by ANSI X9 and ISO/IEC/ITU for X.509 v2 CRLs provide methods for associating additional attributes with CRL entries. The X.509 v2 CRL format also allows communities to define private CRL entry extensions to carry information unique to those communities. Each extension in a CRL entry may be designated as critical or non-critical. A CRL validation MUST fail if it encounters a critical CRL entry extension which it does not know how to process. However, an unrecognized non-critical CRL entry extension may be ignored.

In the preferred embodiment, the secure identification of a revoked certificate consists of computing a fingerprint over the Distinguished Encoding Rules (DER) encoding of the certificate and then inserting the fingerprint in the “certFingerprint” extension in the “crlEntryExtensions” field shown in FIG. 6. The Distinguished Encoding Rules for ASN.1, abbreviated DER, are a subset of BER (Basic Encoding Rules), and give exactly one way to represent any ASN.1 value as an octet string. DER is intended for applications in which a unique octet string encoding is needed, as is the case when a digital signature is computed on an ASN.1 value. DER is defined within the X.509 standard. A cryptographically secure message digest takes arbitrary-sized input (a byte array), and generates a fixed-size output, called a digest or hash. A digest has the following properties: it should be computationally infeasible to find two messages that hash to the same value; the digest does not reveal anything about the input that was used to generate it. Message digests are used to produce unique and reliable identifiers of data. They are sometimes called the “digital fingerprints” of data.

The “certFingerprint” extension contains two data items: the computed fingerprint, “fingerprint”; and “algorithm”, an algorithm identifier that was used to compute the fingerprint. “AlgorithmIdentifier” is defined by IETF RFC 2459 and is used to enable exploiters of this extension to adopt any known digest algorithms, such as MD5 and SHA-1, and then convey that adoption to a validating application via the CRL.

The certificate fingerprint of the present invention is significantly useful because a serial number is just one informative data item, and an error within a certifying authority that causes a serial number to be used in more than one certificate may cause confusion and loss of confidence in the authenticity of all certificates issued by the certifying authority.

In contrast, the certificate fingerprint of the present invention encodes multiple informative data items into a single data item. The fingerprint is computed over multiple fields within the certificate. Even in the unlikely situation in which a certifying authority mistakenly uses a serial number more than once, it is even less unlikely that the certifying authority will use the serial number for two different entities that have other information in common. For example, it is highly unlikely that the certifying authority would issue two certificates with identical serial numbers to two different entities with the same subject name, key usage, and extensions. Hence, the certificate fingerprints would be different even if the serial numbers were the same.

The content within the certificate fingerprint extension may have a variety of formats or data structures and is not limited to that shown in FIG. 6. The methodology is generic enough to allow for an agreement on different data structures and data items. It should be noted that the certificate fingerprint is not limited to being incorporated within only the X.509 standard and that the X.509 standard is merely one set of definitions of digital certificates in which the certificate fingerprint of the present invention could be incorporated; the present invention may also use other digital certificate standards or formats other than X.509 as long as the digital certificates can convey the required information.

Moreover, the certificate fingerprint does not necessarily have to be incorporated as an extension into an X.509 CRL, and that over time, as the X.509 standard changes, the certificate fingerprint of the present invention could become a standard field of a CRL.

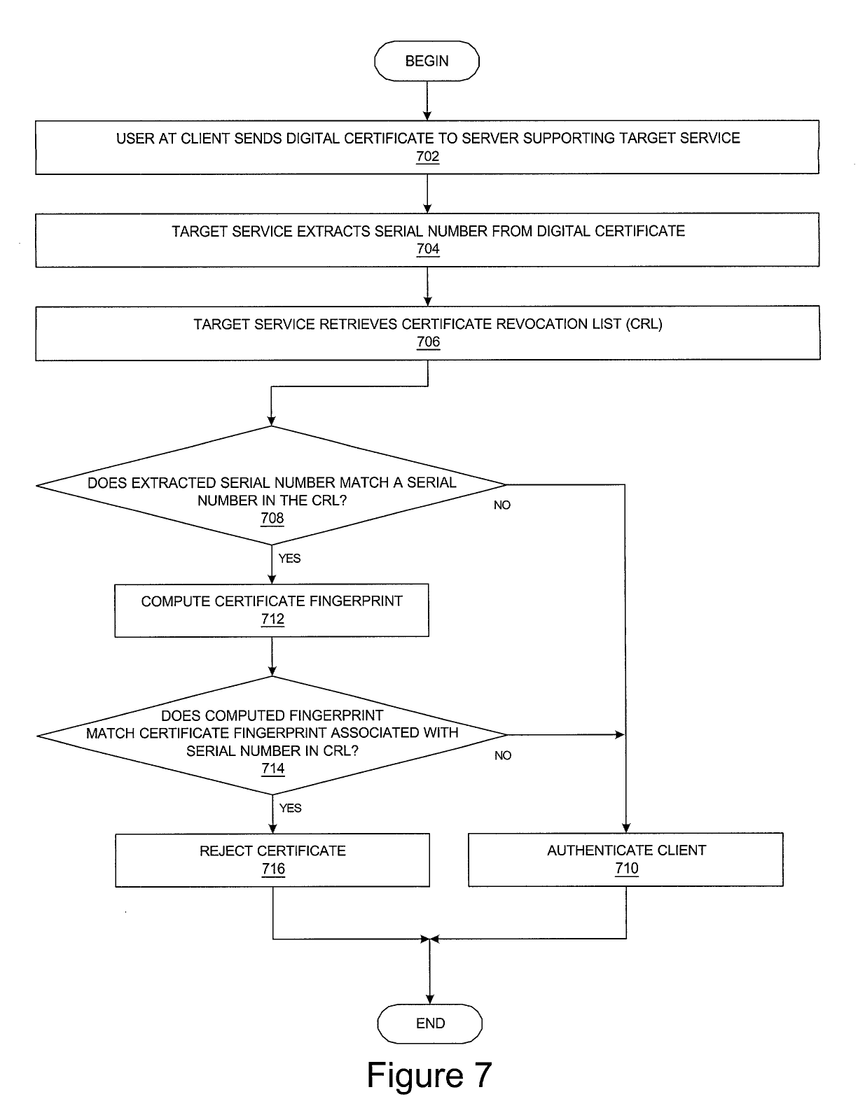

With reference now to FIG. 7, a flowchart depicts the processing of a certificate revocation list for authenticating a certificate holder on a system using the certificate fingerprint methodology of the present invention. The processing begins in FIG. 7 with a user at a client system sending a certificate to a server supporting a target service (step 702). The target service extracts the serial number from the digital certificate (step 704) and retrieves a current CRL from an appropriate entity or repository (step 706).

A determination is then made as to whether the extracted serial number matches one of the serial numbers within the retrieved CRL (step 708). If not, then assuming that the digital certificate has been verified with respect to other matter, the target service has authenticated the client (step 710), and the authentication process is complete.

If a serial number match is made, then the target service computes a certificate fingerprint for the certificate (step 712), and a determination is made whether the computed certificate fingerprint matches the certificate fingerprint associated with the matching serial number in the CRL (step 714).

If the certificates do not match, then assuming that the digital certificate has been verified with respect to other matter, the target service has authenticated the client (step 710), and the authentication process is complete. In this case, however, the fact that the serial numbers matched might be logged or reported to the certifying authority for corrective action.

If the certificate fingerprints match, then a conclusive determination has been made that the presented digital certificate matches a revoked certificate as indicated within the CRL, and the target service rejects or invalidates the presented digital certificate (step 716). The process of authenticating the client through a digital certificate in conjunction with a certificate revocation list containing certificate fingerprints is then complete.

The advantages of the present invention should be apparent in view of the detailed description of the invention that is provided above. In the prior art, a potential problem arises in PKIX because of the fact that a certificate's membership in a CRL is mostly decided based upon the certificate's serial number. If two certificates happen to correspond to the same serial number for any reason, the serial number's membership within a CRL will lead to erroneous but possibly unwarranted decisions. From a perspective of ensuring security, the determination that a certificate is valid or invalid is certainly of the same importance as the assurance that an X.509 certificate provides to its associated public key.

The present invention enables an application that is validating a certificate to have a high level of assurance when verifying the membership of a certificate within a particular CRL. First, the application checks whether a certificate's serial number is found within a CRL, and if there is a successful comparison within the serial numbers, then the fingerprint of the certificate is computed based on the digest algorithm found in the CRL, and the fingerprint is then compared to the certificate's fingerprint as previously stored within the CRL. The verification methodology provided by the present invention lessens the chances that a given certificate would be improperly rejected or invalidated.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for validating a digital certificate within a data processing system, the method comprising:
receiving a digital certificate;
retrieving a certificate revocation list;
extracting a first serial number from the digital certificate, wherein the first serial number has been associated with the digital certificate by a certifying authority;
determining whether the first serial number matches a second serial number stored within the certificate revocation list;
in response to a determination that the first serial number matches the second serial number, computing a first certificate fingerprint for the digital certificate; and
comparing the first certificate fingerprint with a second certificate fingerprint stored within the certificate revocation list, wherein the second certificate fingerprint is associated with the second serial number.

2. The method of claim 1 further comprising:
in response to a determination that the first certificate fingerprint matches the second certificate fingerprint, invalidating the digital certificate.

3. The method of claim 1 further comprising:
in response to a determination that the first certificate fingerprint does not match the second certificate fingerprint, validating the digital certificate.

4. The method of claim 1 wherein the digital certificate and the certificate revocation list are formatted according to the X.509 standard.

5. The method of claim 1 wherein the second certificate fingerprint is stored within an X.509 extension within the certificate revocation list.

6. The method of claim 1 wherein the step of computing a first certificate fingerprint for the digital certificate uses a digest algorithm in accordance with a digest algorithm identifier stored in association with the second certificate fingerprint.

7. A method for revoking a digital certificate, the method comprising:
receiving a serial number for a digital certificate, wherein the serial number has been associated with the digital certificate by a certifying authority;
creating an entry in a certificate revocation list for the digital certificate, wherein the entry comprises the serial number for the digital certificate;
computing a certificate fingerprint for the digital certificate; and
storing the certificate fingerprint within the entry in the certificate revocation list for the digital certificate.

8. The method of claim 7 wherein the digital certificate and the certificate revocation list are formatted according to the X.509 standard.

9. The method of claim 7 wherein the certificate fingerprint is stored within an X.509 extension within the entry in the certificate revocation list for the digital certificate.

10. The method of claim 7 further comprising:
storing a digest algorithm identifier in association with the certificate fingerprint within the entry in the certificate revocation list for the digital certificate that identifies a digest algorithm that has been used to compute the certificate fingerprint.

11. An apparatus for validating a digital certificate within a data processing system, the apparatus comprising:
receiving means for receiving a digital certificate;
retrieving means for retrieving a certificate revocation list;
extracting means for extracting a first serial number from the digital certificate, wherein the first serial number has been associated with the digital certificate by a certifying authority;
determining means for determining whether the first serial number matches a second serial number stored within the certificate revocation list;
computing means for computing in response to a determination that the first serial number matches the second serial number, a first certificate fingerprint for the digital certificate; and
comparing means for comparing the first certificate fingerprint with a second certificate fingerprint stored within the certificate revocation list, wherein the second certificate fingerprint is associated with the second serial number.

12. The apparatus of claim 11 further comprising:
invalidating means for invalidating the digital certificate in response to a determination that the first certificate fingerprint matches the second certificate fingerprint.

13. The apparatus of claim 11 further comprising:
validating means for validating the digital certificate in response to a determination that the first certificate fingerprint does not match the second certificate fingerprint.

14. The apparatus of claim 11 wherein the digital certificate and the certificate revocation list are formatted according to the X.509 standard.

15. The apparatus of claim 11 wherein the second certificate fingerprint is stored within an X.509 extension within the certificate revocation list.

16. The apparatus of claim 11 wherein the computing means uses a digest algorithm in accordance with a digest algorithm identifier stored in association with the second certificate fingerprint.

17. An apparatus for revoking a digital certificate, the apparatus comprising:
receiving means for receiving a serial number for a digital certificate, wherein the serial number has been associated with the digital certificate by a certifying authority;
creating means for creating an entry in a certificate revocation list for the digital certificate, wherein the entry comprises the serial number for the digital certificate;
computing means for computing a certificate fingerprint for the digital certificate; and
first storing means for storing the certificate fingerprint within the entry in the certificate revocation list for the digital certificate.

18. The apparatus of claim 17 wherein the digital certificate and the certificate revocation list are formatted according to the X.509 standard.

19. The apparatus of claim 17 wherein the certificate fingerprint is stored within an X.509 extension within the entry in the certificate revocation list for the digital certificate.

20. The apparatus of claim 17 further comprising:
second storing means for storing a digest algorithm identifier in association with the certificate fingerprint within the entry in the certificate revocation list for the digital certificate that identifies a digest algorithm that has been used to compute the certificate fingerprint.

21. A computer program product in a computer readable medium for use in a data processing system for validating a digital certificate, the computer program product comprising:
instructions for receiving a digital certificate;
instructions for retrieving a certificate revocation list;
instructions for extracting a first serial number from the digital certificate, wherein the first serial number has been associated with the digital certificate by a certifying authority;
instructions for determining whether the first serial number matches a second serial number stored within the certificate revocation list;
instructions for computing, in response to a determination that the first serial number matches the second serial number, a first certificate fingerprint for the digital certificate; and
instructions for comparing the first certificate fingerprint with a second certificate fingerprint stored within the certificate revocation list, wherein the second certificate fingerprint is associated with the second serial number.

22. The computer program product of claim 21 further comprising:
instructions for invalidating the digital certificate in response to a determination that the first certificate fingerprint matches the second certificate fingerprint.

23. The computer program product of claim 21 further comprising:
instructions for validating the digital certificate in response to a determination that the first certificate fingerprint does not match the second certificate fingerprint.

24. The computer program product of claim 21 wherein the digital certificate and the certificate revocation list are formatted according to the X.509 standard.

25. The computer program product of claim 21 wherein the second certificate fingerprint is stored within an X.509 extension within the certificate revocation list.

26. The computer program product of claim 21 wherein the instructions for computing a first certificate fingerprint for the digital certificate uses a digest algorithm in accordance with a digest algorithm identifier stored in association with the second certificate fingerprint.

27. A computer program product in a computer readable medium for use in a data processing system for revoking a digital certificate, the computer program product comprising:
instructions for receiving a serial number for a digital certificate, wherein the serial number has been associated with the digital certificate by a certifying authority;
instructions for creating an entry in a certificate revocation list for the digital certificate, wherein the entry comprises the serial number for the digital certificate;
instructions for computing a certificate fingerprint for the digital certificate; and
instructions for storing the certificate fingerprint within the entry in the certificate revocation list for the digital certificate.

28. The computer program product of claim 27 wherein the digital certificate and the certificate revocation list are formatted according to the X.509 standard.

29. The computer program product of claim 27 wherein the certificate fingerprint is stored within an X.509 extension within the entry in the certificate revocation list for the digital certificate.

30. The computer program product of claim 27 further comprising:
instructions for storing a digest algorithm identifier in association with the certificate fingerprint within the entry in the certificate revocation list for the digital certificate that identifies a digest algorithm that has been used to compute the certificate fingerprint.

31. A data structure representing a certificate revocation list for use in a data processing system, the data structure comprising:
a serial number of a revoked digital certificate; and
a certificate fingerprint for the revoked digital certificate.

32. The data structure of claim 31 wherein the certificate revocation list contains a plurality of entries, wherein each entry corresponds to a revoked digital certificate, and wherein the serial number and the certificate fingerprint of the revoked digital certificate are stored within an entry.
